(19) United States
(12) Patent Application Publication
(10) Pub. No.: US 2010/0039248 A1
(43) Pub. Date: Feb. 18, 2010

(54) Vehicle window position indicator

(76) Inventor: Eric Mauro, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/583,135

(22) Filed: Aug. 12, 2009

Related U.S. Application Data
(60) Provisional application No. 61/188,641, filed on Aug. 12, 2008.

(51) Int. Cl. G08B 21/00; B60Q 1/00; B60Q 1/26

(52) U.S. Cl. 340/438; 340/686.1; 340/433

(57) ABSTRACT

A device for installation in an automobile including a passenger car, minivan or bus (e.g., a school bus) indicates the position of each window and emergency exit of the vehicle and sounds an alarm to indicate to the driver of the vehicle that one or more of the windows and/or emergency exits is open. The alarm may be a combination of a visual lighted display on the driver console and/or an audible alarm indicator. The visual indicator may further indicate the operative position of any particular window or emergency door opening between the closed position, slight open, half open and fully open positions. The device alerts the driver of the vehicle to correct the window position of each window and emergency exit of the vehicle for purposes of safety as well as to prevent robbery and/or damage to the vehicle (e.g., from rain, sprinklers, etc.) when leaving the vehicle unoccupied. The device may also alert the driver to crack the windows partially open when leaving a pet in the vehicle for a short time.

This application is based on provisional patent application serial no. 61/188,641 filed on Aug. 12, 2008.

### BACKGROUND OF THE INVENTION

1. Field of the Invention

The present invention relates to a window indicator device for vehicles and, more particularly, to a vehicle window position indicator for indicating the operative position of each window of a vehicle and including an audible and/or visual alarm for alerting the driver of the window positions.

2. Discussion of the Related Art

In many vehicles, particularly larger vehicles such as a minivan or bus, it is difficult for the driver to determine the position of each window of the vehicle. For purposes of safety, such as on a school bus, it is important that the windows remain closed while the vehicle is moving and children or other occupants are riding in the bus. It is also important that all emergency exits remain closed during operation of the vehicle. However, it is difficult for the driver to visually determine the position of each window and emergency exit, particularly on a school bus, when the driver is behind the wheel. When leaving a vehicle, including a small passenger automobile (e.g., a two or four door passenger car) it is important that the windows be either fully closed or, in some instances, slightly cracked open for ventilation purposes.

In the above examples, it is often difficult for the driver of the vehicle to both visually determine the position of the windows and to remember to position the windows at a desired position when leaving the vehicle.

Accordingly, there remains a need for an automatic vehicle window position indicator and alarm device that visually and audibly indicates to the vehicle operator the position of each window of the vehicle. This would allow the driver of the vehicle to not only know the position of each window, but to control the window positions to the desired position for purposes for safety and security.

### SUMMARY OF THE INVENTION

The present invention is directed to a device for installation in an automobile including a passenger car, minivan or bus (e.g., a school bus) indicates the position of each window and emergency exit of the vehicle and sounds an alarm to indicate to the driver of the vehicle that one or more of the windows and/or emergency exits is open. The alarm may be a combination of a visual lighted display on the driver console and/or an audible alarm indicator. The visual indicator may further indicate the operative position of any particular window or emergency door opening between the closed position, slight open, half open and fully open positions. The device alerts the driver of the vehicle to correct the window position of each window and emergency exit of the vehicle for purposes of safety as well as to prevent robbery and/or damage to the vehicle (e.g., from rain, sprinklers, etc.) when leaving the vehicle unoccupied. The device may also alert the driver to crack the windows partially open when leaving a pet in the vehicle for a short time.

### BRIEF DESCRIPTION OF THE DRAWINGS

For a fuller understanding of the nature of the present invention, reference should be made to the detailed description taken in conjunction with the accompanying drawings in which:

FIG. 1 is a perspective view of a school bus;

FIG. 2 is a rear elevational view of the school bus;

FIG. 3 is a top plan view of the interior of the school bus showing the window and exit locations;

FIG. 4 is a general diagram of a visual display indicator for use on the school bus of FIGS. 1-3 for indicating the open or closed condition of each window, door and emergency exit of the school bus;

FIG. 5 is a plan view of an automobile driver console showing the visual and audible indicator of the invention on the driver console;

FIG. 6 is a general diagram of a window and hatch back indicator for an automobile; and

FIG. 7 is a general diagram showing a visual window position indicator for a minivan in accordance with a further embodiment of the present invention.

Like reference numerals refer to like parts throughout the several views of the drawings.

### DETAILED DESCRIPTION OF THE PREFERRED EMBODIMENTS

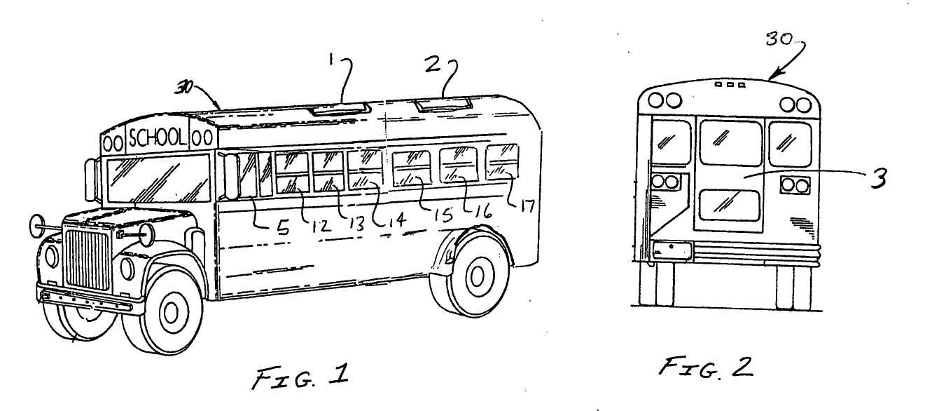

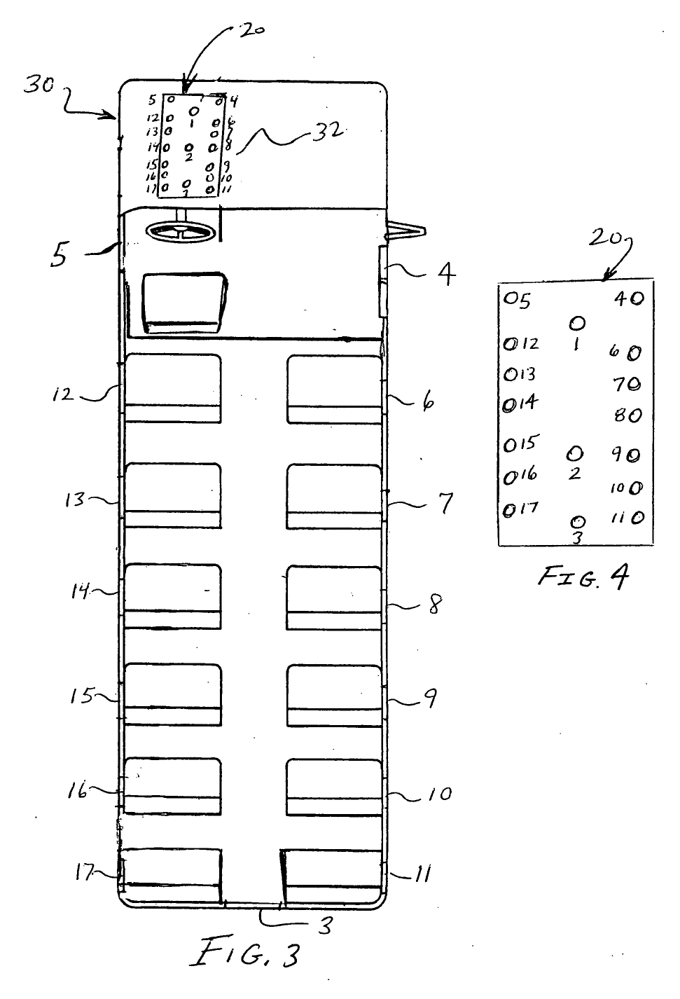

Referring to the several views of the drawings, and initially FIGS. 1-4 the vehicle window position indicator 20 is useful for indicating the position of windows, doors and emergency exits of a vehicle, such as school bus 30. As seen in FIG. 1, the school bus 30 includes a number of openings 1-17 which should remain closed during normal operation when children are riding on the school bus. In particular, the school bus 30 includes emergency exits 1 and 2 on the roof, a rear emergency exit door 3, a normal entry and exit door 4 at the front of the bus, a driver window 5, and a plurality of windows 6-17 at each seating row. Referring to FIG. 3, a visual and audible indicator display 20 of the invention is shown for use on the school bus for indicating the open or closed condition of each door, emergency exit and window of the school bus. The indicator display 20 may include a separate LED or other light indicator for each door, emergency exit and window of the bus. A corresponding number may be assigned to each door and window opening directly adjacent to the LED on the indicator display 20. In the event any window, door or emergency exit of the bus is open or ajar, the light (LED) corresponding with that door, exit or window illuminates on the display 20 at the driver console 32. This enables the bus driver to immediately determine the open condition of any window, exit or door of the bus and the exact location of the open window, exit or door. The bus driver may then take immediate action to ensure that the window, exit or door is closed for purposes of safety.

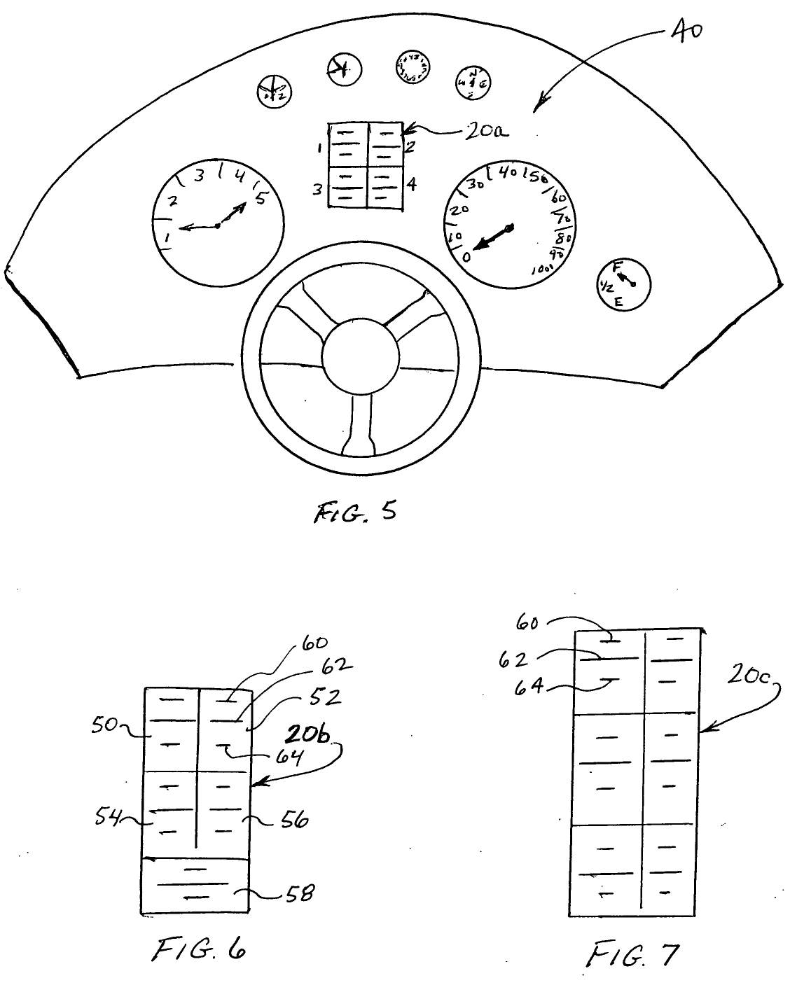

Referring to FIG. 5, a typical driver console 40 of a passenger vehicle is shown and includes a visual and audible indicator 20a of the present invention. FIGS. 6 and 7 illustrate the visual and audible indicator display in more detail and may include visual indicators for alerting the driver to the exact position of any window or opening (e.g., hatchback) of the vehicle. FIG. 6 shows an example of a window position indicator 20b for an SWV or hatchback automobile, with visual window position indicators for the driver window 50, front passenger seat window 52, rear passenger seat windows 54, 56 and rear window or hatchback 58. FIG. 7 shows an example of a window position indicator 20c for a minivan. The visual indicator shows the position of any particular window between the fully closed position, partially cracked position, half open position, three-quarter position or fully open position of any window in the vehicle. The illuminating indicators on the display 20a-20c including line segments for each of these window positions at each window location of the vehicle. More specifically, each window position indicator has a first illuminating line segment 60 to indicate a partially cracked window position, a second illuminating line segment 62 to indicate a half open position and a third illuminating line segment 64 to indicate a three-quarter to fully open window position. While driving, the driver of the vehicle may wish to know if any window is open or ajar. Moreover, when leaving the vehicle, an alarm may sound to alert the driver that one or more windows are open. Alternatively, the device of the present invention may be set to alert the driver if all windows are closed. This may be important if the driver is leaving a pet unattended in the vehicle for a short period of time, in which case it is important to leave all windows slightly cracked. Accordingly, the device will alert the driver as to the position of each window when leaving the vehicle so that the driver may take appropriate action to control the windows to the desired positions.

While the present invention has been shown and described in accordance with preferred and practical embodiments thereof, it is recognized that departures from the instant disclosure are contemplated within the spirit and scope of the invention.

What is claimed is:

1. A display system for indicating vehicle window position comprising:
a visual indicator display located at a position viewable by a driver of the vehicle, said visual indicator display being structured and disposed for indicating the position of each of a plurality of openings on a vehicle; and
an audible indicator structured and disposed for indicating the position of each of said plurality of openings on the vehicle.

2. The system as recited in claim 1 wherein said visual indicator display indicates the position of each of said plurality of openings between a fully closed position, a one-quarter open position, a half open position, a three-quarter open position, and a fully open position.

3. The system as recited in claim 2 further comprising:
a plurality of light generating sources structured and disposed for indicating the position of each of said plurality of openings.

4. The system as recited in claim 3 wherein said audible indicator alerts the driver if each of said plurality of openings are closed when the driver exits the vehicle.

5. The system as recited in claim 4 wherein said audible indicator alerts the driver if any of said plurality of openings are open when the driver exits the vehicle.

6. A display system for indicating vehicle window position comprising:
a visual indicator display located at a position viewable by a driver of the vehicle, said visual indicator display being structured and disposed for indicating the position of each of said plurality of openings between a fully closed position, a one-quarter open position, a half open position, a three-quarter open position, and a fully open position; and
an audible indicator structured and disposed for indicating the position of each of said plurality of openings on the vehicle.

7. The system as recited in claim 6 further comprising:
a plurality of light generating sources structured and disposed for indicating the position of each of said plurality of openings.

8. The system as recited in claim 7 wherein said audible indicator alerts the driver if each of said plurality of openings are closed when the driver exits the vehicle.

9. The system as recited in claim 8 wherein said audible indicator alerts the driver if any of said plurality of openings are open when the driver exits the vehicle.
